(19) United States
(12) Patent Application Publication
(10) Pub. No.: US 2011/0309806 A1
(43) Pub. Date: Dec. 22, 2011

(54) Rotor Electromagnetically Coupled with Stator

(76) Inventors: Nikola Milivojevic, Flagstaff, AZ (US); Igor Stamenkovic, Flagstaff, AZ (US); Nigel Schofield, Lancashire (GB); Anthony J. Baroud, Prospect Heights, IL (US)

(21) Appl. No.: 13/203,517

(22) PCT Filed: Feb. 27, 2009
(86) PCT No.: PCT/US09/35472

§ 371 Date: Aug. 26, 2011

(51) Int. Cl. H02P 9/02; H02K 3/24

(52) U.S. Cl. 322/94; 310/52

(57) ABSTRACT

An apparatus in an example comprises a stator and a rotor. The stator comprises one or more coils. At least one coil of the one or more coils comprises one or more windings about a hollow spool. The hollow spool comprises a stator conveyor. The stator conveyer comprises a coolant that is located on an inner surface of the hollow spool. The rotor is electromagnetically coupled with the stator. The rotor comprises a plurality of permanent magnets.

### BACKGROUND

Electric motors and electric generators are examples of electric machines. An electric motor uses electrical energy to produce mechanical energy. The reverse process that uses mechanical energy to produce electrical energy is accomplished by a generator or alternator. Electric motor and electric generator have stationary and rotary part—the stationary part is a stator, and non-stationary part is a rotor. Stator and rotor are coupled electromagnetically, through magnetic fields that are formed on stator and rotor. Depending on the configuration of a spinning electromotive device the stator may act as the field winding, interacting with the armature to create motion, or it may act as the armature, receiving its influence from moving magnetic field on the rotor.

### DESCRIPTION OF THE DRAWINGS

Features of exemplary implementations of the invention will become apparent from the description, the claims, and the accompanying drawings in which:

FIG. 1 is a representation of an implementation of an apparatus that comprises a stator, a stator conveyor, coils, a coolant, a rotor, a rotor rail, and permanent magnets.

FIG. 2 is a representation of a side perspective of an implementation of the apparatus of FIG. 1.

FIGS. 3 to 7 illustrate complementary shapes of at least one coil and at least one permanent magnet of an implementation of the apparatus of FIG. 1.

FIG. 8 is a representation of a side perspective of an implementation of the apparatus of FIG. 1, and illustrates a first rotor rail, a second rotor rail, and the stator spaced apart coaxially with respect to an axis and the stator located between the first rotor rail and the second rotor rail in a direction of the axis.

FIG. 9 is a representation of a side perspective of an implementation of the apparatus of FIG. 1, and illustrates a first rotor rail located concentrically internal to the stator, and a second rotor rail located concentrically external to the stator.

FIG. 10 is a representation of a side perspective of an implementation of the apparatus of FIG. 1, and illustrates a first rotor rail located concentrically internal to the stator, a second rotor rail located concentrically external to the stator, and a third rotor rail located coaxially to the stator with respect to the axis.

FIGS. 11 to 14 illustrate one permanent magnet that comprises a plurality of permanent magnet sub-portions of an implementation of the apparatus of FIG. 1.

FIG. 15 illustrates a plurality of windings of the stator about the hollow spool of an implementation of the apparatus of FIG. 1, wherein each winding is disconnected from a remainder of the windings.

FIG. 16 illustrates the coil with radial orientation with respect to the rotor of an implementation of the apparatus of FIG. 1.

FIG. 17 illustrates first and third rotor rails, and second and fourth rotor rails, and the stator spaced apart coaxially with respect to an axis of an implementation of the apparatus of FIG. 1.

FIG. 18 illustrates the stator, the stator conveyor, a plurality of circumferentially placed windings, the coolant, the rotor, and a plurality of permanent magnets.

FIG. 19 is a representation of an implementation of the apparatus of FIG. 1 that further comprises a controller, a power converter, one or more feedback signals, and one or more control signals.

FIG. 20 is a representation of an implementation of the apparatus of FIG. 1 that comprises a plurality of radially placed windings and a plurality of permanent magnets.

FIG. 21 is a representation of an implementation of the apparatus of FIG. 1 that illustrates an in-wheel propulsion application.

FIG. 22 is a representation of an implementation of the apparatus of FIG. 1 that illustrates a wind turbine application.

### DETAILED DESCRIPTION

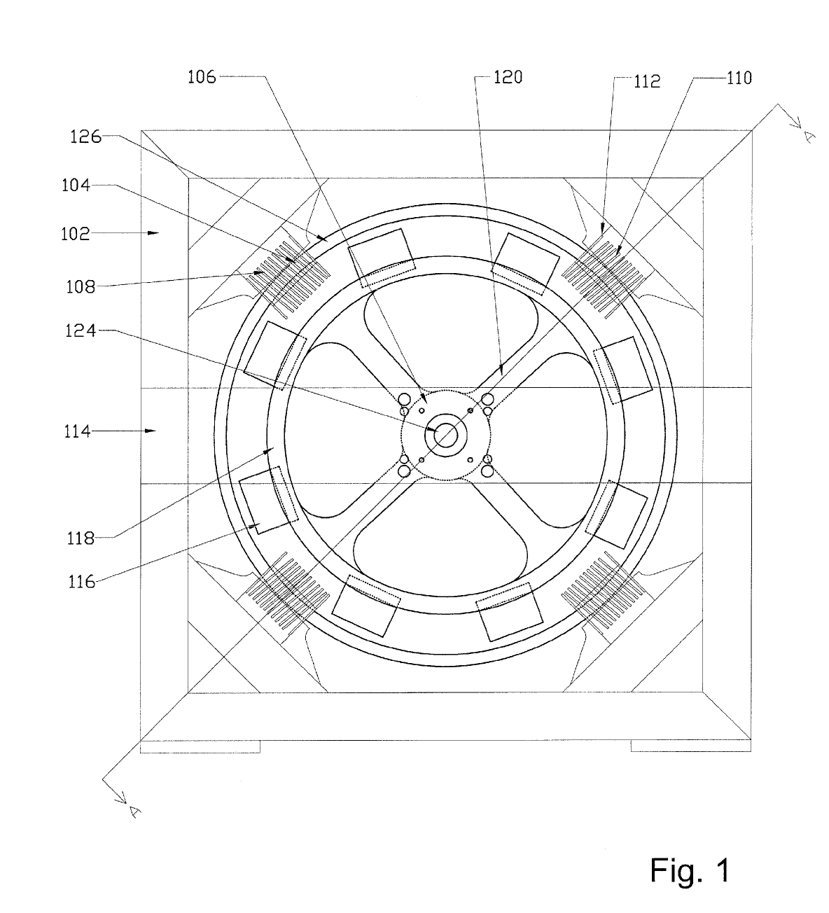

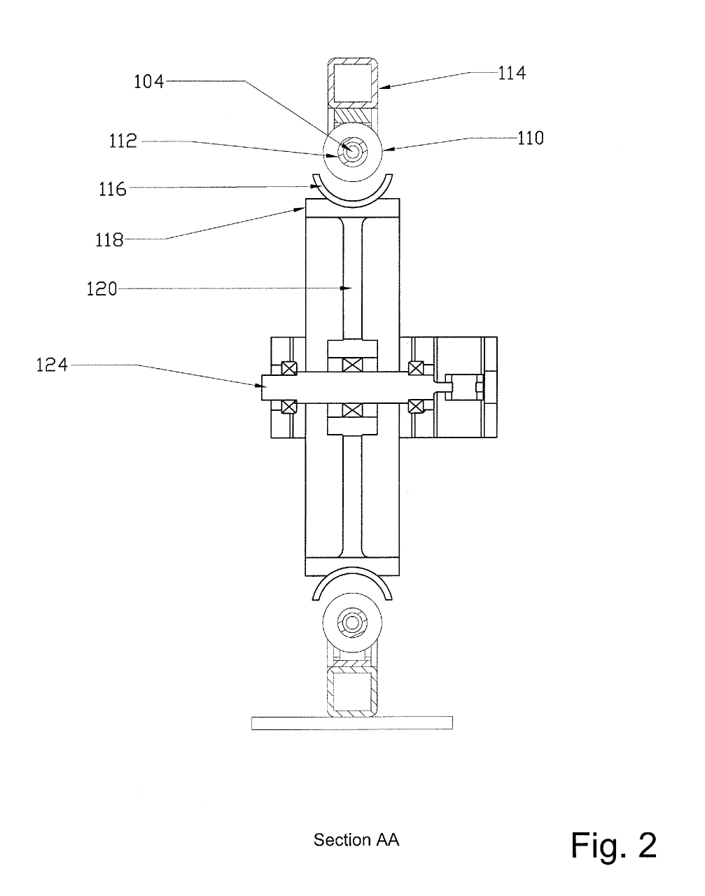

Turning to FIG. 1, an implementation of an apparatus 100 comprises a stator 102 and a rotor 106. An exemplary apparatus 100 comprises an electric machine which can act as a generator and/or a motor depending on the energy flow direction. For example, when energy conversion comprises changing from mechanical energy into electrical energy, the apparatus 100 in an example serves as an electric generator. When energy conversion comprises changing from electrical energy into mechanical energy, the apparatus 100 in an example serves as an electric motor. FIG. 2 is a representation of a side perspective of an implementation of the apparatus 100.

Referring to FIG. 1, the stator 102 comprises one or more coils 108. At least one coil 108 of the one or more coils 108 comprises one or more windings 110 about a hollow spool 112. The hollow spool 112 comprises a stator conveyor 126. The stator conveyer 126 comprises a coolant 104 that is located on an inner surface of the hollow spool 112. The rotor 106 is electromagnetically coupled with the stator 102. The rotor 106 comprises a plurality of permanent magnets 116.

The stator 102 in an example comprises one or more coils 108, one or more stator conveyors 126, and a stator support 114. The stator conveyor 126 serves to carry the coolant 104. The coil 108 comprises a winding 110 and a hollow spool 112. The rotor 106 in an example comprises one or more rotor rails 118, carrying a plurality of permanent magnets 116, and a rotor support 120. The rotor 106 in an example is electromagnetically coupled to the stator 102. The electromagnetic coupling is provided through magnetic fields created via one or more of the coils 108 on the stator 102 and the plurality of permanent magnets 116 on the rotor 106.

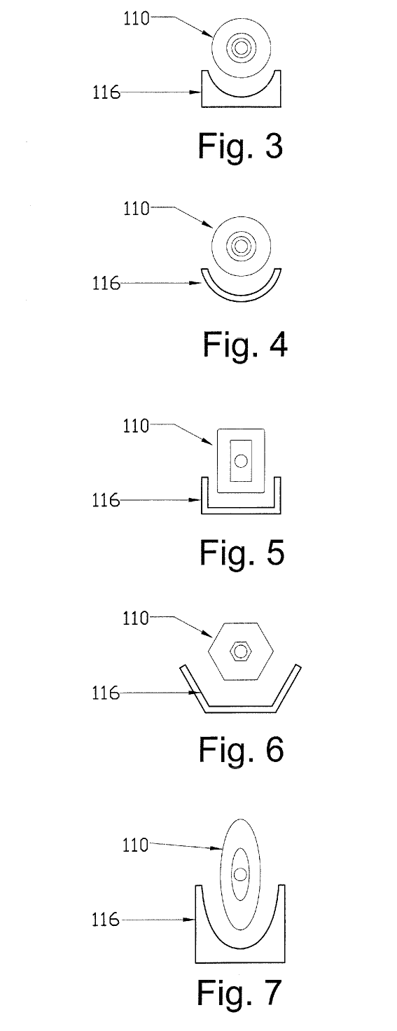

The electromagnetic coupling in an example comprises two or more coils 108, the coolant 104, and at least one permanent magnet 116 of the plurality of permanent magnets 116. The two or more coils 108, the coolant 104, and at least one permanent magnet 116 in an example comprise electromagnetically complementary shapes. Complementary shapes in an example means that at least one coil 108 and at least one permanent magnet 116 comprise facing surfaces that are spaced apart substantially uniformly. For example, FIGS. 3 to 7 show different complementary shapes of at least one coil 108 and at least one permanent magnet 116. Exemplary complementary shapes may comprise curved, rectangular, octagonal, and/or ellipsoidal shapes.

Complementary in an example means that at least one coil 108, the coolant 104, and the at least one permanent magnet 116 serve to create an electromagnetic coupling that is substantially uniform. Exemplary uniformity in the magnetic field causes a majority of the magnetic field coming from the rotor 106 to be coupled with the stator 102.

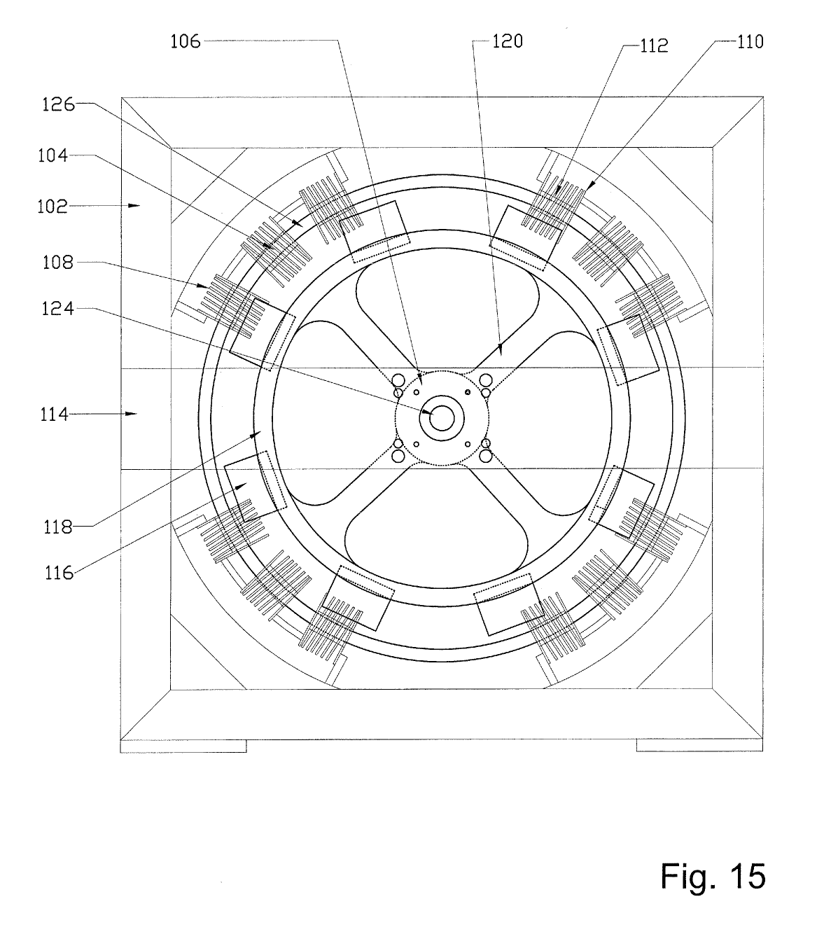

The winding 110 in an example comprises a material that conducts electricity. The hollow spool 112 in an example comprises magnetic and/or non-magnetic material. At least one coil 108 in an example comprises a plurality of windings 110 about the hollow spool 112. The plurality of windings 110 in an example has each winding 110 disconnected from a remainder of the plurality of windings. For example, the plurality of winding 110 is placed in the space directly and/or right across one or more permanent magnets 116. For example, one to fifteen windings 110 may be located in the space right across one or more permanent magnets 116. For example, FIG. 15 illustrates a plurality of, e.g., three windings 110 located directly across two permanent magnets 116. FIG. 15 is a representation of an implementation of the apparatus 100 that comprises a plurality of, e.g., three windings 110 of the stator 102 about the hollow spool 112, wherein each winding 110 of the plurality of, e.g., three windings 110 is disconnected from a remainder of the windings 110.

The winding 110 in an example comprises a plurality of turns around the hollow spool 112. One or more implementations may employ a variety of ranges of turns of the winding 110 about the hollow spool 112. There can be different ranges or sub-ranges of numbers of turns of the winding 110 about the hollow spool 112; for example, a first range or sub-range is between 1 and 1,500 turns; for example, a second range or sub-range is between 1,501 and 4,500 turns; for example, a third range or sub-range is between 4,501 and 10,000 turns; for example, a fourth range or sub-range is between 10,001 and 50,000 turns; for example, a fifth range or sub-range is between 50,001 and 150,000 turns.

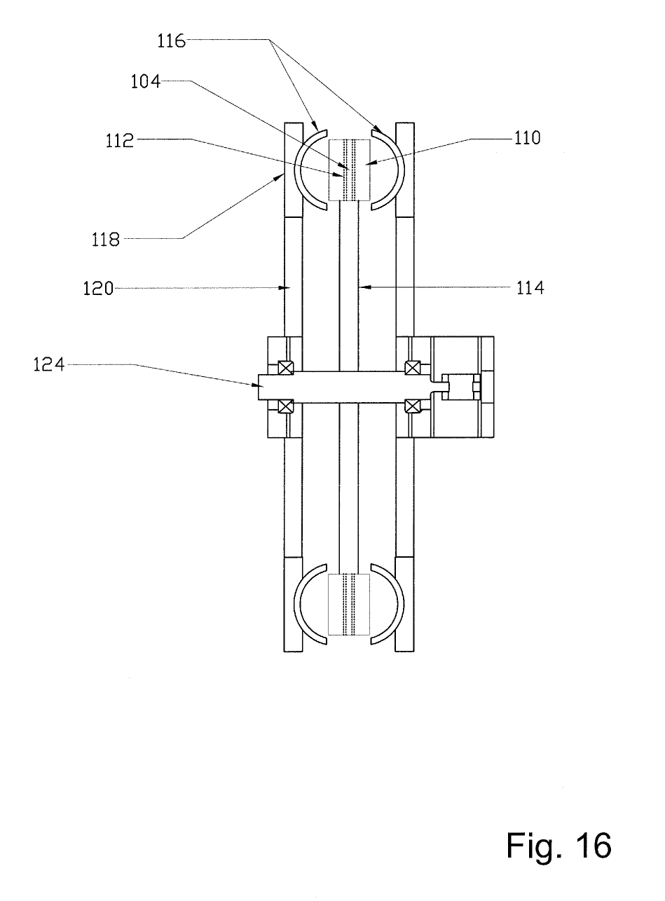

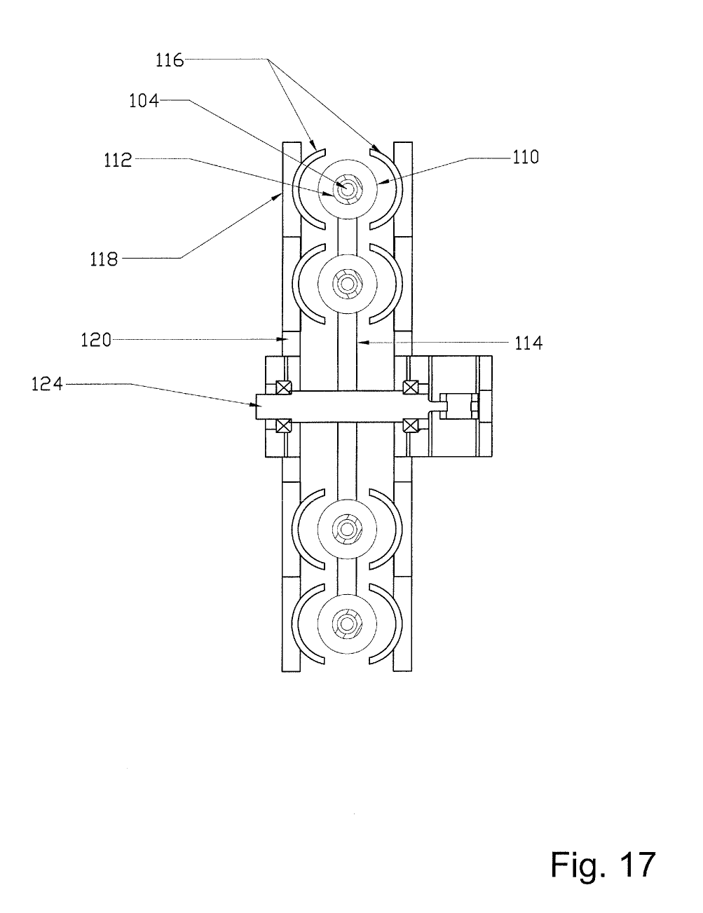

The hollow spool 112 in an example comprises one or more stator conveyors 126. The stator conveyor 126 in an example comprises continuous and/or discrete portions that comprise one or more windings 110 and the coolant 104. For example, FIG. 17 shows two concentric continuous stator conveyors 126; for example, FIG. 1 shows one continuous stator conveyor; for example, FIG. 16 shows two discrete stator conveyors 126. FIG. 16 is a representation of an implementation of the apparatus 100 that comprises the coil 108 with radial orientation with respect to the rotor 106. Referring to FIG. 16, at least one coil 108 may be located radially with respect to the rotor 106.

FIG. 17 is a representation of a side perspective of an implementation of the apparatus 100 that comprises the first and the third rotor rails 118, and the second and the fourth rotor rails 118, and the stator 102 that are spaced apart coaxially with respect to a shaft and/or axis 124, wherein the stator 102 is located between the first and the third rotor rails 118 and the second and the fourth rotor rails 118 in a direction of the axis 124. Further, the first and the second rotor rail 118 are located concentrically external to the third and the fourth rotor rails 118. For example, a central axis of the shaft 124 may represent axial axis around which the rotor 106 rotates.

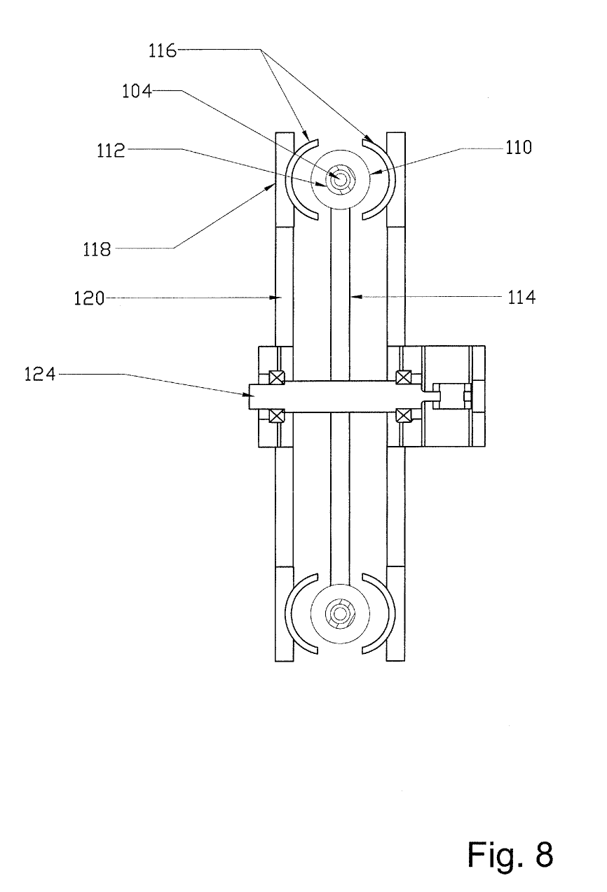

The coolant 104 comprises one or more of gas, air, liquid, water, solid, magnetic material, and/or iron. Gas, air, liquid, and/or water may be circulating naturally, or supplied by an external source (not shown), as will be appreciated by those skilled in the art. The coolant 104 may reside inside the hollow spool 112 or within the stator conveyor 126. For example, FIG. 8 shows the coolant residing inside the spool; for example, FIG. 1 shows the coolant residing in the stator conveyor 126.

The coolant 104 as gas, air, liquid and/or water may serve to decrease the temperature of the hollow spool 112 and one or more windings 110. The coolant 104 as magnetic material and/or iron may serve to change the frequency and the amplitude of magnetic flux and magnetic field between the stator 102 and the rotor 106.

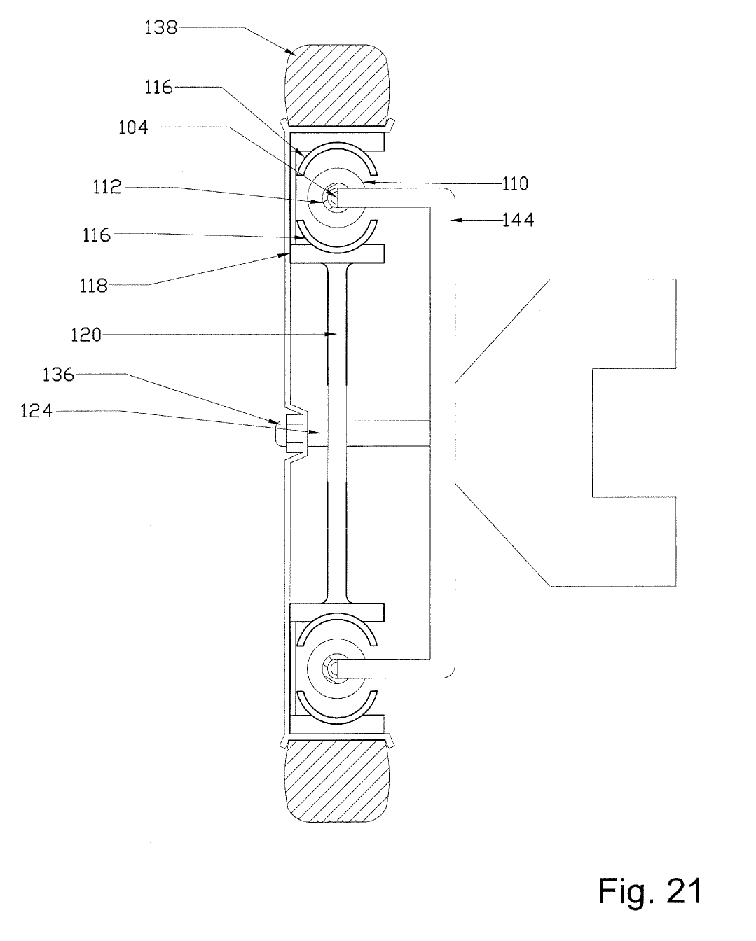

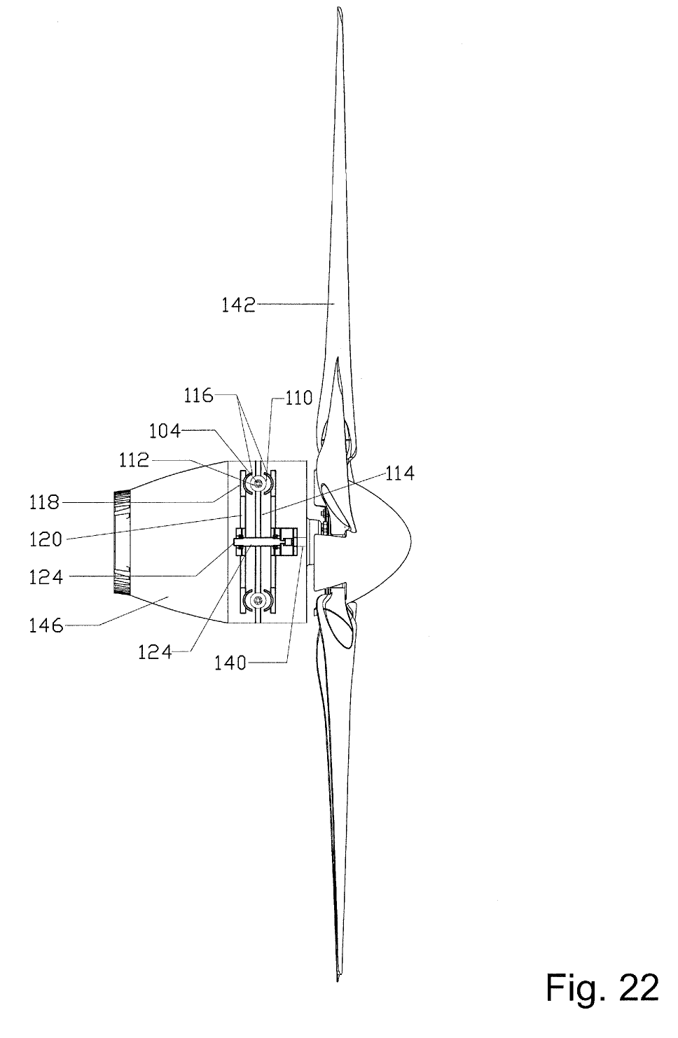

One or more implementations of the stator support 114 may comprise magnetic and/or non-magnetic material of different shapes that may be coordinated with the targeted surrounding and/or environment of the apparatus 100. For example, FIG. 21 illustrates an in-wheel propulsion application, for example, with the stator support 114, e.g., firmly mounted and incorporated in part of a vehicle shell 144. For example, FIG. 22 illustrates a wind turbine application wherein the stator support 114 is firmly mounted and incorporated in the turbine nacelle 146. FIG. 22 is a representation of an implementation of the apparatus 100 that illustrates a small wind turbine application with the stator support 114, for example, firmly mounted and incorporated in the turbine nacelle 146.

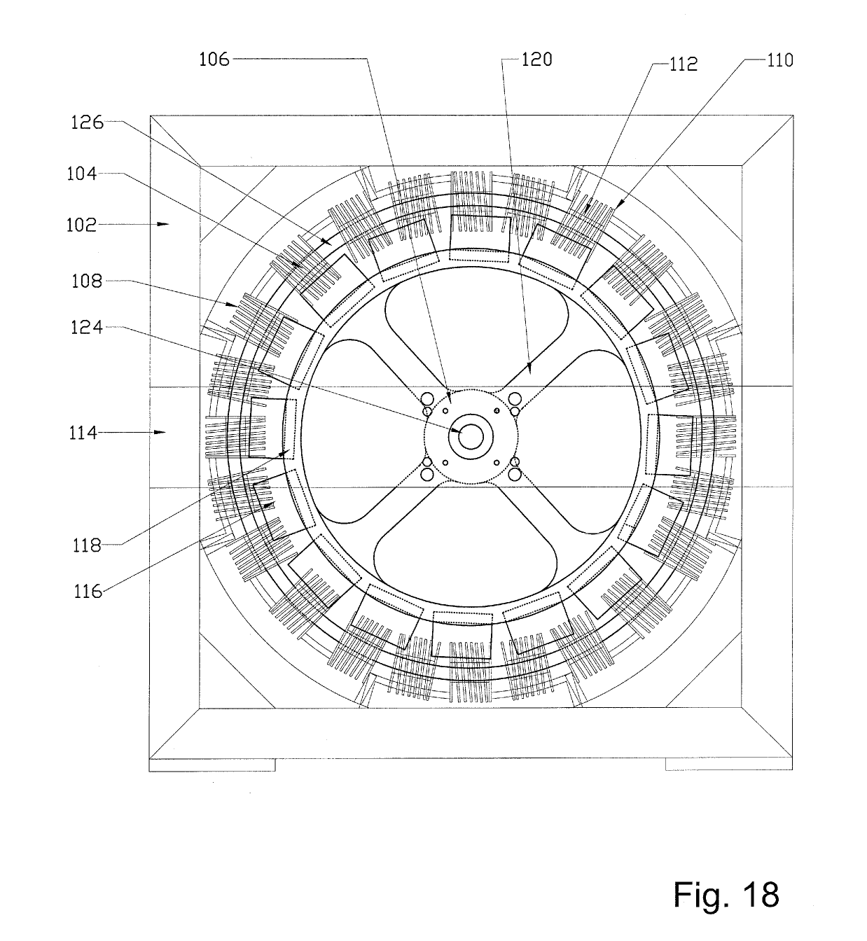

The rotor rail 118 in an example comprises magnetic and/or non-magnetic material. Permanent magnets 116 are located on the one or more rotor rails 118. There can be different range in number of permanent magnets 116. For example, the range is between two and one hundred permanent magnets 116 on each rotor rail 118. For example, FIG. 1 shows one rotor rail 118 and eight permanent magnets 116; for example, FIG. 18 shows one rotor rail 118 and a plurality of, e.g., sixteen permanent magnets 116; for example, FIG. 17 shows eight rotor rails 118. FIG. 17 is a representation of a side perspective of an implementation of the apparatus 100 that comprises the first and the third rotor rails 118, and the second and the fourth rotor rails 118, and the stator 102 that are spaced apart coaxially with respect to an axis 124, wherein the stator 102 is located between the first and the third rotor rails 118 and the second and the fourth rotor rails 118 in a direction of the axis 124. Further, the first and the second rotor rail 118 are located concentrically external to the third and the fourth rotor rails 118. FIG. 18 is a representation of an implementation of the apparatus 100 that comprises the stator 102, the stator conveyor 126, a plurality of, e.g., twenty-four circumferentially placed windings 110, the coolant 104, the rotor 106, and a plurality of, e.g., sixteen permanent magnets 116.

Turning to FIG. 8, a first rotor rail 118, a second rotor rail 118, and the stator conveyor 126 are spaced apart coaxially with the stator conveyor 126 located between the first rail 118 and the second rail 118 along a shaft and/or axis 124. The shaft 124 in an example comprises an axis 124 for the first rotor rail 118 and the second rotor rail 118. FIG. 8 is a representation of a side perspective of an implementation of the apparatus 100 that comprises the first rotor rail 118, the second rotor rail 118, and the stator 102 that are spaced apart coaxially with respect to the axis 124 and the stator 102 located between the first rotor rail 118 and the second rotor rail 118 in a direction of the axis 124.

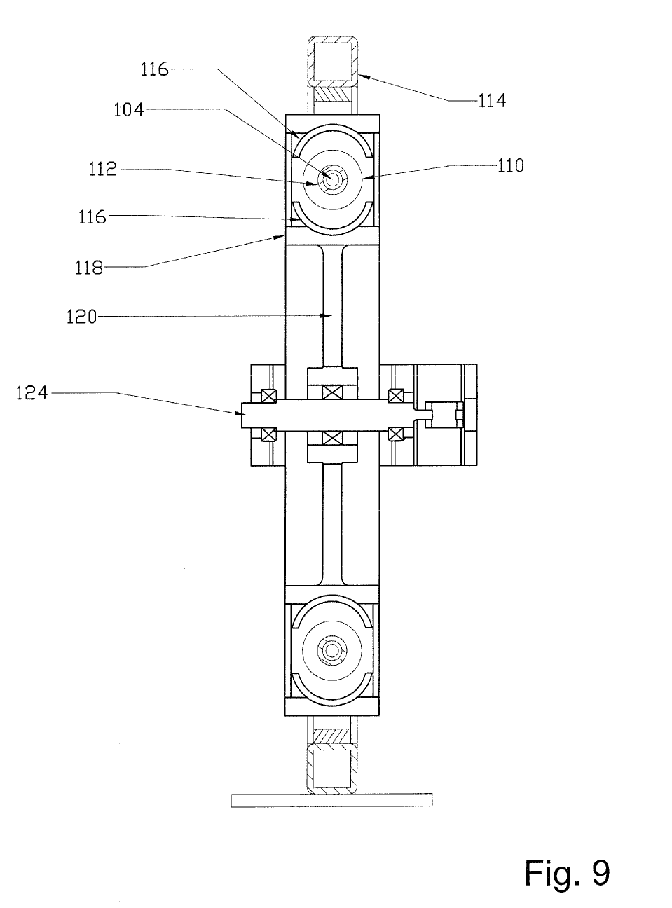

Turning to FIG. 9, one or more rotor rails 118 comprise a first rotor rail 118 and a second rotor rail 118 that are positioned concentrically, wherein the first rail 118 is located internal to the stator conveyor 126, wherein the second rotor rail 118 is located external to the stator conveyor 126. FIG. 9 is a representation of a side perspective of an implementation of the apparatus 100 that comprises the first rotor rail 118 located concentrically internal to the stator 102, and the second rotor rail 118 located concentrically external to the stator 102.

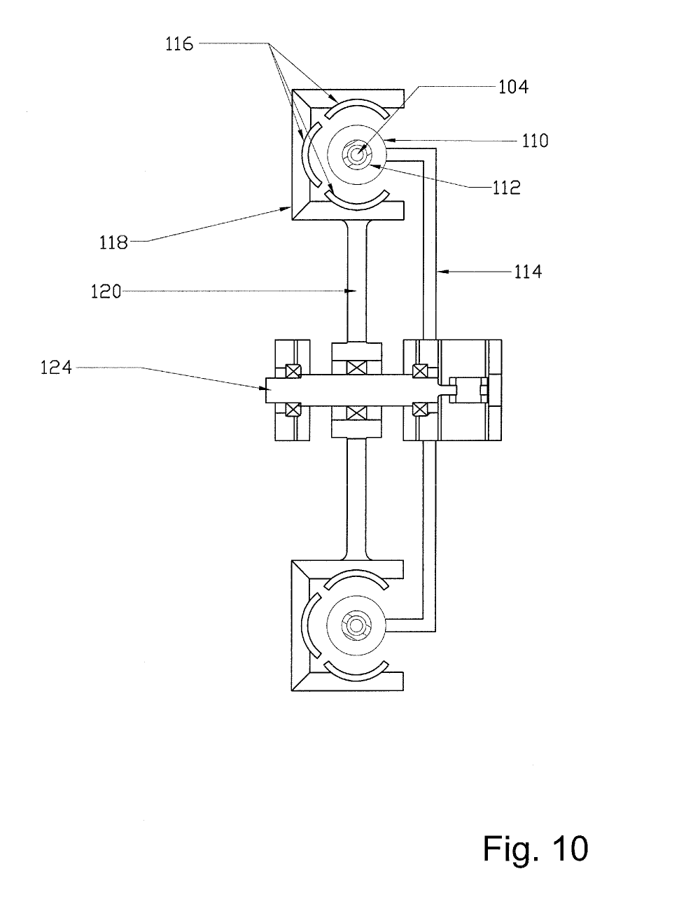

Turning to FIG. 10, the first rotor rail 118 is located concentrically internal to the stator conveyor 126, the second rotor rail 118 is located concentrically external to the stator conveyor 126, and the third rotor rail 118 is located coaxially to the stator conveyor 126 in respect to an axis 124. FIG. 10 is a representation of a side perspective of an implementation of the apparatus 100 that comprises the first rotor rail 118 located concentrically internal to the stator 102, the second rotor rail 118 located concentrically external to the stator 102, and the third rotor rail 118 located coaxially to the stator 102 with respect to the axis 124.

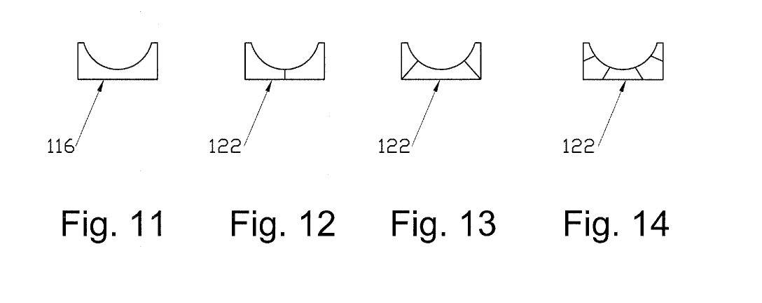

FIGS. 11 to 14 represent a side perspective of an implementation of the apparatus 100 that illustrates one permanent magnet 116 that comprises a plurality of permanent magnet sub-portions 122. Each permanent magnet 116 comprises one or many sub-portions 122. Sub-portion 122 comprises magnetic and/or non-magnetic material. For example, FIG. 11 shows permanent magnet 116 that comprises one sub-portion 122. For example, FIGS. 12-14 show permanent magnet 116 that comprises many sub-portions 122. The plurality of permanent magnets 116 may comprise a first permanent magnet 116 and a second permanent magnet 116, where the first permanent magnet 116 and the second permanent magnet 116 may comprise a same polarity.

Another implementation in an example may comprise a first permanent magnet 116 and a second permanent magnet 116, wherein the first permanent magnet 116 and the second permanent magnet 116 comprise an opposite polarity. One or more implementations of the rotor support 120 may comprise one or more rotor rails 118 and a shaft 124. The rotor support 120 comprises magnet and/or non-magnetic materials of different shapes that may be coordinated with the targeted surrounding and/or environment of the apparatus 100. For example, FIG. 21 illustrates an in-wheel propulsion application, for example, with the rotor support 120, e.g., firmly mounted and incorporated in part of a vehicle/wheel shaft 136 and tires 138. For example, FIG. 21 illustrates a small wind turbine application wherein the rotor support 120 is firmly mounted and coupled with the turbine shaft 140 and/or the blades 142.

A magnetic field is providing electromagnetic coupling between the stator 102 and the rotor 106. Magnetic field is the result of the current in the winding 108 and rotation of the permanent magnets 116. The frequency and the amplitude of this magnetic field change with the change of the current in the windings 110 of the stator 102, and the change of the rotational speed of the permanent magnets 116 mounted on the rotor rails 118. The amplitude of the magnetic field can be increased because of the coolant 104; for example, the coolant 104 that comprises gas, air, liquid, and/or water provides possibilities for higher amplitudes of current in the windings 110 of the stator 102; for example, the coolant 104 that comprises magnetic material provides possibilities for higher magnetic field through the coolant 104.

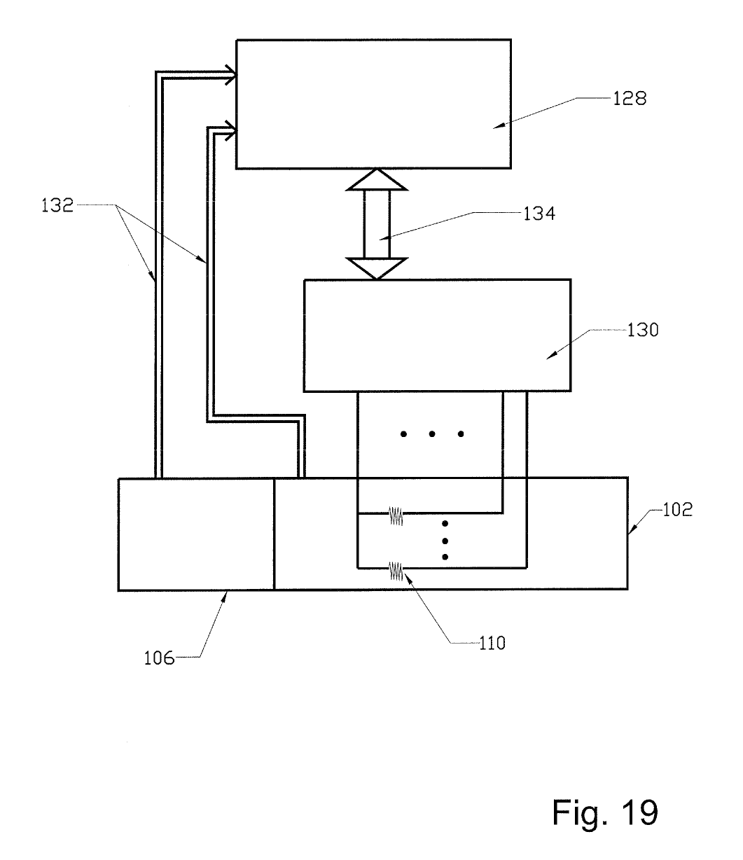

Turning to FIG. 19, the apparatus 100 in an example further comprises a controller 128, a power converter 130, one or more feedback signals 132, and one or more control signals 134. The control signals 134 go in both directions, meaning that one or more signals are sent from the controller 128 to the power converter 130, and zero or more signals are send from the power converter 130 to the controller 128.

In an example, the feedback signal 132 is received at the controller 128 from the power converter 130, the stator 102 and/or the rotor 106. The feedback signal 132 represents a status of one or more windings 110 of the stator 102 and the coolant 104. The feedback signal 132 is employed at the controller 128 to adjust the control signal 134. The control signal 134 is sent from the controller 128 to the power converter 130. The control signal 134 is employed at the power converter 130 to turn ON or turn OFF a current in the one or more windings 110 of the stator 102. A rotation of the rotor 106 and the current in the one or more windings 110 of the stator 102 serve to create an electromagnetic coupling between the stator 102 and the rotor 106.

The feedback signal is employed at the controller to adjust a control signal. The control signal 134 is sent from the controller to a power converter. The control signal is employed at the power converter to turn ON or turn OFF a current in the one or more windings of the stator. A rotation of the rotor and the current in the one or more windings of the stator serve to create magnetic fields that provide electromagnetic coupling between the stator 102 and the rotor 106.

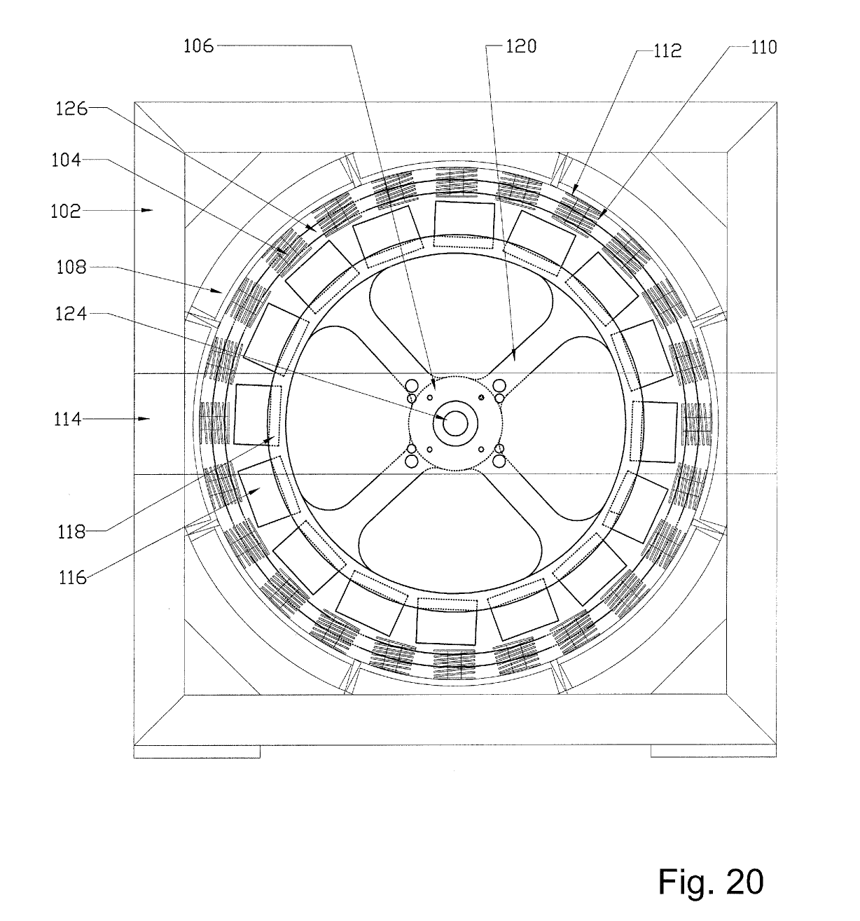

For example, one implementation of apparatus 100 comprises of a stator 102, a stator conveyor 126, a coolant 104, a rotor 106, and a rotor rail 118. The stator 102 comprises plurality of coils 108. The rotor 106 comprises plurality of permanent magnets 116. The coolant 104 comprises iron. The rotor rail 118 comprises iron. Permanent magnets 116 comprise the first and the second permanent magnet, wherein the first permanent magnet and the second permanent magnet comprise opposite magnetization. The coolant 104, the coil 108 and permanent magnet 116 have complementary curved surfaces. The coil 108 comprises plurality of windings 110, wherein each winding 110 of the plurality of windings is disconnected from a remainder of the plurality of windings. The number of disconnected windings 110 is in the range between 1 and 15. The number of permanent magnets 116 is in the range between 8 and 128. The number of coils 128 is in the range between 1 and 128. The number of windings 110 is in the range between 3 and 384. For example, FIG. 18 illustrates a plurality of, e.g., twenty-four circumferentially positioned coils wherein a plurality of, e.g., three windings are disconnected, and a plurality of, e.g., sixteen permanent magnets. For example, FIG. 20 illustrates a plurality of, e.g., twenty-four radially positioned coils wherein a plurality of, e.g., three windings are disconnected, and a plurality of, e.g., sixteen permanent magnets.

An implementation of the apparatus 100 comprises a plurality of components such as one or more of electronic components, chemical components, organic components, mechanical components, hardware components, optical components, and/or computer software components. A number of such components can be combined or divided in an implementation of the apparatus 100. In one or more exemplary implementations, one or more features described herein in connection with one or more components and/or one or more parts thereof are applicable and/or extendible analogously to one or more other instances of the particular component and/or other components in the apparatus 100. In one or more exemplary implementations, one or more features described herein in connection with one or more components and/or one or more parts thereof may be omitted from or modified in one or more other instances of the particular component and/or other components in the apparatus 100. An exemplary technical effect is one or more exemplary and/or desirable functions, approaches, and/or procedures. An exemplary component of an implementation of the apparatus 100 employs and/or comprises a set and/or series of computer instructions written in or implemented with any of a number of programming languages, as will be appreciated by those skilled in the art. An implementation of the apparatus 100 comprises any (e.g., horizontal, oblique, angled, or vertical) orientation, with the description and figures herein illustrating an exemplary orientation of an exemplary implementation of the apparatus 100, for explanatory purposes.

The steps or operations described herein are examples. There may be variations to these steps or operations without departing from the spirit of the invention. For example, the steps may be performed in a differing order, or steps may be added, deleted, or modified.

Although exemplary implementation of the invention has been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. An apparatus, comprising:
a stator including at least one coil, wherein said at least one coil is configured to include a coolant therein;
a coolant contained within said at least one coil; and
a rotor electromagnetically coupled with the stator, wherein said rotor comprises a plurality of permanent magnets.

2-20. (canceled)

21. The apparatus in accordance with claim 1 wherein said at least one coil includes a hollow spool configured to receive at least one winding and to include said coolant therein.

22. The apparatus in accordance with claim 1 wherein said at least one coil includes a stator conveyor and said stator conveyor includes said coolant therein.

23. The apparatus in accordance with claim 1 wherein said rotor is a driving member of said apparatus and said apparatus is an electric motor.

24. The apparatus in accordance with claim 1 wherein said rotor is a driven member of said apparatus and said apparatus is an electric generator.

25. The apparatus in accordance with claim 1 wherein said rotor is both a driving member and a driven member of said apparatus and said apparatus is both an electric motor and an electric generator, respectively.

26. The apparatus in accordance with claim 1 wherein said coolant contained within said at least one coil is selected from the group consisting of gas and liquid and wherein said coolant decreases a temperature of said at least one coil.

27. The apparatus in accordance with claim 26 wherein said gas comprises air.

28. The apparatus in accordance with claim 26 wherein said liquid comprises water.

29. The apparatus in accordance with claim 1 wherein said coolant contained within said at least one coil is a solid.

30. The apparatus in accordance with claim 29 wherein said coolant comprises a magnetic material.

31. The apparatus in accordance with claim 29 wherein said coolant comprises iron.

32. The apparatus in accordance with claim 29 wherein said coolant comprises a non-magnetic material.

33. The apparatus in accordance with claim 1 further including at least one rotor rail configured for carrying said plurality of permanent magnets.

34. The apparatus in accordance with claim 33 wherein said at least one rotor rail comprises magnetic material.

35. The apparatus in accordance with claim 33 wherein said at least one rotor rail comprises non-magnetic material.

36. The apparatus in accordance with claim 1, wherein at least one of said at least one coil and at least one of said plurality of permanent magnets are formed in electromagnetically complementary shapes.

37. The apparatus in accordance with claim 1, wherein at least one of said at least one coil and at least one of said plurality of permanent magnets each comprise a facing surface and said facing surface of each are spaced apart substantially uniformly.

38. The apparatus in accordance with claim 1, wherein at least one of said at least one coil and at least one of said plurality of permanent magnets are configured to create an electromagnetic coupling that is substantially uniform between the stator and the rotor.

39. The apparatus in accordance with claim 1, wherein at least one of said plurality of permanent magnets comprises a plurality of sub-portions wherein each of said plurality of sub-portions are magnetic.

40. The apparatus in accordance with claim 1, wherein at least one of said plurality of permanent magnets comprises a plurality of sub-portions wherein at least one of said plurality of sub-portions is magnetic and at least one of said plurality of sub-portions is non-magnetic.

41. The apparatus in accordance with claim 33, wherein said apparatus includes at least one stator conveyor, wherein said at least one rotor rail comprises a first rotor rail and a second rotor rail disposed in concentric relationship, wherein the first rotor rail is disposed radially internal said at least one stator conveyor and wherein said second rotor rail is disposed radially external to said at least one stator conveyor.

42. The apparatus in accordance with 33, wherein said apparatus includes at least one stator conveyor, wherein said at least one rotor rail comprises a first rotor rail having an axis of rotation, wherein said first rotor rail and said at least one stator conveyor are spaced apart radially with respect to said axis of rotation.

43. The apparatus in accordance with claim 42, wherein said first rotor rail is disposed between said axis of rotation and said at least one stator conveyor.

44. The apparatus in accordance with claim 42, wherein said at least one stator conveyor is disposed between said axis of rotation and said first rotor rail.

45. The apparatus in accordance with claim 32, wherein said apparatus includes at least one stator conveyor, wherein said at least one rotor rail comprises a first rotor rail and a second rotor rail having a common axis of rotation, wherein said first rotor rail and said at least one stator conveyor are spaced apart axially with respect to said axis of rotation and said one of said at least one stator conveyor is disposed between said first and second rotor rails.

46. The apparatus in accordance with claim 32, wherein said apparatus includes at least one stator conveyor, wherein said at least one rotor rail comprises a first rotor rail and a second rotor rail having a common axis of rotation, wherein said first rotor rail and said at least one stator conveyor are spaced apart axially with respect to said axis of rotation and wherein said second rotor rail and said at least one stator conveyor is are spaced apart radially.

47. The apparatus in accordance with claim 46 wherein said second rotor rail is disposed between said stator conveyor and said axis of rotation.

48. The apparatus in accordance with claim 46 wherein said stator conveyor is disposed between said second rotor rail and said axis of rotation.

49. The apparatus in accordance with claim 1, wherein the plurality of permanent magnets comprises a first permanent magnet and a second permanent magnet, wherein the first permanent magnet and the second permanent magnet comprise a same polarity.

50. The apparatus in accordance with claim 1, wherein the plurality of permanent magnets comprises a first permanent magnet and a second permanent magnet, wherein the first permanent magnet and the second permanent magnet comprise an opposite polarity.

51. The apparatus in accordance with claim 1, wherein said at least one coil comprises a first and second winding, wherein said first winding is mechanically disconnected from said second winding.

52. The apparatus in accordance with claim 1, wherein a centerline of said at least one coil is oriented radially with respect to an axis of rotation of said rotor.

53. The apparatus in accordance with claim 1, wherein a centerline of said at least one coil is oriented circumferentially with respect to an axis of rotation of said rotor.

54. The apparatus in accordance with claim 23, wherein the rotor is rotatably coupled to a vehicle shaft.

55. The apparatus in accordance with claim 24, wherein the rotor is rotatably coupled to a vehicle shaft.

56. The apparatus in accordance with claim 25, wherein the rotor is rotatably coupled to a vehicle shaft.

57. The apparatus in accordance with claim 24, wherein the rotor is coupled to a wind turbine shaft.

58. A method of controlling the output of a generator, wherein said generator includes a stator, a coil and a coolant contained within said coil, said method comprising the steps of:
a) receiving a feedback signal at a controller from at least one of a power converter, said stator or said rotor wherein said feedback signal represents a status of at least one winding of said stator and a status of said coolant;
b) employing said feedback signal at the controller to adjust a control signal;
c) sending said control signal from the controller to a power converter; and
d) employing the control signal at the power converter to switch ON or switch OFF a current in at least one of said at least one winding of the stator;
wherein a rotation of said rotor and said switched current result in an electromagnetic coupling between the stator and the rotor.
